(19) United States
(12) Patent Application Publication
(10) Pub. No.: US 2011/0076360 A1
(43) Pub. Date: Mar. 31, 2011

(54) DISPOSABLE WHOLE BEAN COFFEE FILTER

(76) Inventor: BARBARA L SCHNABEL, CHAPPAQUA, NY (US)

(21) Appl. No.: 12/884,318

(22) Filed: Sep. 17, 2010

Related U.S. Application Data
(60) Provisional application No. 61/244,304, filed on Sep. 21, 2009.

(51) Int. Cl. B65B 29/02; A23F 5/00

(52) U.S. Cl. 426/77

(57) ABSTRACT

A pre-packaged, sealed container enclosing whole coffee beans is sized to correspond to a single serving of coffee, or multiple servings. The container is used with a machine that selectively lowers a grinding blade into the container for grinding the whole beans. The freshly made grounds remain in the same container and heated water is introduced into the container. Freshly brewed coffee is produced and drips out of one or more openings in the bottom of the container after passing through the filter. The container is sealed for storage and shipping with an airtight membrane or cover such as plastic, foil etc.

### CROSS-REFERENCE TO RELATED APPLICATIONS

This application relates to and claims priority from U.S. Provisional Application 61/244304.

### BACKGROUND OF THE INVENTION

The present invention relates to electric appliances and, more particularly, to electric coffee makers.

### DESCRIPTION OF RELATED ART

Various design exist for electric coffee makers. Drip-style coffee makers utilize a brew basket that holds coffee grounds and a filter, and heated water is delivered into the basket and, under the force of gravity, brewed coffee drips out of the brew basket. Certain known coffee makers include a grinding feature in which hole coffee beans are placed into a grinding chamber and a grinding operation is carried out. After grinding, the grounds are transferred to a brew basket and the drip-style operation is carried out.

It is desirable to clean grinding chambers and blades of debris and oils from the coffee beans. It is desirable to clean the brew basket also. Both can be inconvenient or difficult to clean.

### OBJECT OF THE PRESENT INVENTION

It is an object of the present invention to provide a grinding and brewing means for whole bean coffee that overcomes the shortcomings described above.

These and other objects are achieved by the present invention disclosed herein.

### DESCRIPTION OF THE PREFERRED EMBODIMENT OF THE PRESENT INVENTION

The present invention comprises use of a pre-packaged, sealed container enclosing whole coffee beans. The quantity of beans and the size of the container may correspond to a single serving of coffee, or multiple servings. The container is designed to be used with a machine that selectively introduces a grinding blade into the container for grinding the whole beans. The blade may be lowered into the container, the container may be raised into engagement with the blade, or a combination of both may occur. The freshly made grounds remain in the same container and heated water is introduced into the container. Freshly brewed coffee is produced and drips out of one or more openings in the bottom of the container after passing through the filter. The container is sealed for storage and shipping with an airtight membrane or cover such as plastic, foil etc. The seal is removed by the user before grinding and brewing.

Grinding operations may be automatically or manually timed to ensure adequate grinding. Water portions can be dependent upon user's manual input or managed by automatic controls and valves.

After use, the container is removed and discarded, eliminating the need for cleanup associated with known grinding and brewing machines.

While the preferred embodiment of the present invention has been disclosed herein, it is understood that various modification can be made without departing from the scope of the presently claimed invention.

What is claimed is:

1. A disposable, pre-packaged, whole-bean coffee filter packet, said packet comprising
a sealed container enclosing whole coffee beans.

2. A packet according to claim 1, wherein
said container size and the quantity of coffee beans contained therein corresponds to a single serving of coffee.

3. A packet according to claim 1, wherein
said container size and the quantity of coffee beans contained therein corresponds to a plurality of servings of coffee.

4. A packet according to claim 1, wherein
said container has a top surface that is adapted to be penetrated by a coffee grinding blade for grinding the coffee beans contained therein.

5. A packet according to claim 1, wherein
said container is provided with at least one opening on its bottom to enable brewed coffee to drip thereform after heated water is introduced into said container.

6. A packet according to claim 1, wherein
said container is pre-sealed in an airtight membrane.
